(19) United States
(12) Patent Application Publication
(10) Pub. No.: US 2026/0003774 A1
(43) Pub. Date: Jan. 1, 2026

(54) MEMORY CONTROLLER AND OPERATION METHOD THEREOF

(71) Applicants: SK hynix Inc., Icheon-si (KR); Seoul National University R&DB Foundation, Seoul (KR)

(72) Inventors: Sungjun Jung, Seoul (KR); Sangwoo Kwon, Seoul (KR); Jaewook Lee, Seoul (KR); Yongsang Park, Icheon-si (KR); Young Ook Song, Icheon-si (KR)

(21) Appl. No.: 18/946,506

(22) Filed: Nov. 13, 2024

(30) Foreign Application Priority Data
Jun. 28, 2024 (KR) 10-2024-0085478

(51) Int. Cl. G06F 12/02

(52) U.S. Cl. CPC G06F 12/0223

(57) ABSTRACT

A memory controller includes a host interface circuit configured to receive a host read request, a host write request, and a data block corresponding to the host write request from a host; a compression control circuit configured to generate a compressed data block by compressing the data block based on an N:M sparsity rule and generate a metadata block including metadata for data elements included in the compressed data block; a scheduler configured to schedule a first write command for writing the compressed data block and a second write command for writing the metadata block; and a memory interface circuit configured to transmit a memory command output from the scheduler to a memory device, wherein N and M are natural numbers and an M is greater than N.

### CROSS-REFERENCE TO RELATED APPLICATION

The present application claims priority under 35 U.S.C. § 119 (a) to Korean Patent Application No. 10-2024-0085478, filed on Jun. 28, 2024, which is incorporated herein by reference in its entirety.

### BACKGROUND

### 1. Technical Field

Embodiments generally relate to a memory controller that performs data compression and decompression operations and an operation method thereof.

### 2. Related Art

A technology for storing data matrix adhering to the N:M sparsity rule in a memory device is under development.

The N:M sparsity rule specifies that N elements out of M elements are non-zero. For example, a 4:8 sparsity rule indicates that 4 out of every 8 elements are non-zero.

However, when data matrix that does not adhere to the N:M sparsity rule is input to a conventional memory controller, the controller performs pruning to enforce the N:M sparsity rule and then stores the pruned data. This process can lead to a reduction in the accuracy of neural network operations due to data loss from the pruning.

### SUMMARY

In accordance with an embodiment of the present disclosure, a memory controller may include a host interface circuit configured to receive a host read request, a host write request, and a data block corresponding to the host write request from a host; a compression control circuit configured to generate a compressed data block by compressing the data block based on an N:M sparsity rule and generate a metadata block including metadata for data elements included in the compressed data block; a scheduler configured to schedule a first write command for writing the compressed data block and a second write command for writing the metadata block; and a memory interface circuit configured to transmit a memory command output from the scheduler to a memory device, wherein N and M are natural numbers and an M is greater than N.

In accordance with an embodiment of the present disclosure, an operation method of a memory controller may include receiving a data block corresponding to a host write request from a host; generating a compressed data block by compressing the data block based on an N:M sparsity rule; generating a metadata block including metadata for data elements included in the compressed data block; generating a first write command for writing the compressed data block in a memory device; and generating a second write command for writing the metadata block in the memory device, wherein N and M are natural number and M is greater than N.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a memory controller according to an embodiment of the present disclosure.

FIG. 2 illustrates a compression control circuit according to an embodiment of the present disclosure.

FIGS. 3A to 3C illustrate a data compression operation of a memory controller according to an embodiment of the present disclosure.

FIGS. 4 to 6 illustrate an operation of a memory controller according to an embodiment of the present disclosure.

FIG. 7 illustrates a data structure of a metadata buffer according to an embodiment of the present disclosure.

FIGS. 8A to 8C illustrate an operation of a memory controller according to an embodiment of the present disclosure.

FIG. 9 illustrates a data structure of a mapping table according to an embodiment of the present disclosure.

FIG. 10 illustrates an operation of a memory controller according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

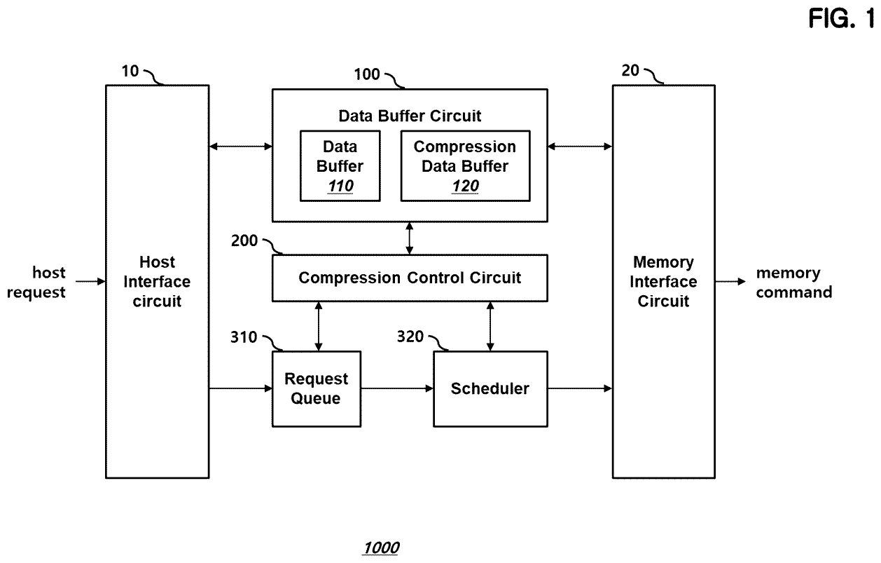

FIG. 1 is a block diagram showing a memory controller 1000 according to an embodiment of the present disclosure.

The memory controller 1000 includes a host interface circuit 10, a memory interface circuit 20, a data buffer circuit 100, a compression control circuit 200, a request queue 310, and a scheduler 320.

The host interface circuit 10 receives a host request provided by an external host (not shown) and manages the transmission and reception of data related to the host request.

The data buffer circuit 100 includes a data buffer 110 and a compression data buffer 120, and it facilitates data transfer between the host interface circuit 10 and the memory interface circuit 20.

For example, write data received from the host interface circuit 10 may be stored in the data buffer 110 and then compressed before being stored in the compression data buffer 120. Similarly, read data received from the memory interface circuit 20 may be stored in the compression data buffer 120 and then decompressed before being stored in the data buffer 110.

The request queue 310 holds host requests received from the host interface circuit 10, with the ability to store read and write requests separately. The host requests include the read and write requests.

When the compression and decompression operations based on the N:M sparsity rule are not performed, the scheduler 320 determines the processing order of a plurality of requests stored in the request queue 310 and stores and outputs memory commands corresponding to these requests. Herein, M and N are natural numbers, and M is greater than N.

When the compression and decompression operations based on the N:M sparsity rule are performed, the compression control circuit 200 may generate one or more memory commands corresponding to a host request provided from the request queue 310 and provide the one or more memory commands to the scheduler 320, which will be described in detail below.

In an embodiment, the scheduler 320 schedules a first write command for writing a compressed data block and a second write command for writing a metadata block.

The memory interface circuit 20 provides the memory commands output from the scheduler 320 to a memory device (not shown). In addition, during a write operation, the memory interface circuit 20 transfers write data from the data buffer circuit 100 to the memory device along with the memory commands. During a read operation, it provides data from the memory device to the data buffer circuit 100.

During a write operation, the compression control circuit 200 generates a plurality of memory commands to store compressed data that adheres to the N:M sparsity rule, based on a host write request.

The data compression operation and the process of storing compressed data to adhere to the N:M sparsity rule will be described in detail below.

In a read operation, the compression control circuit 200 generates one or more read commands in response to a host read request.

The process of decompressing the compressed data read by the read command and recovering original data will be described below.

The compression operation involves storing N data elements out of M data elements, along with metadata corresponding to the N data elements.

For example, when the M data elements form one data block, the metadata represents a location of the N data elements within the data block.

For the compression and decompression operations, the compression control circuit 200 controls the data buffer circuit 100 and the scheduler 320.

If all data blocks adhere to the N:M sparsity rule, the compression and decompression process is relatively simple.

In this embodiment, when a data block does not adhere to the N:M sparsity rule, a row split operation and a row merge operation are performed to store and read data while ensuring compliance with the N:M sparsity rule.

The compression and decompression operations including the row split operation and the row merge operation will be described in detail below.

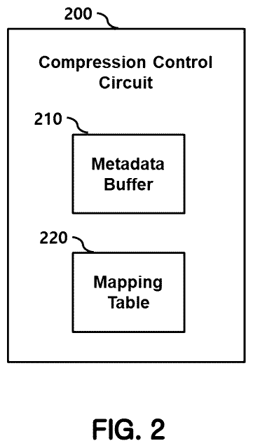

FIG. 2 is a block diagram showing a compression control circuit 200 according to an embodiment of the present disclosure. The compression control circuit 200 shown in FIG. 2 may correspond to the compression control circuit 200 shown in FIG. 1.

The compression control circuit 200 controls read and write operations for a memory device to ensure compliance with the N:M sparsity rule as described above.

In this process, the compression control circuit 200 controls compression and decompression operations, as well as row split and row merge operations.

The compression control circuit 200 includes a metadata buffer 210 and a mapping table 220.

The metadata buffer 210 stores metadata of non-zero data in block units, while the mapping table 230 stores row mapping information required for the row split and row merge operations.

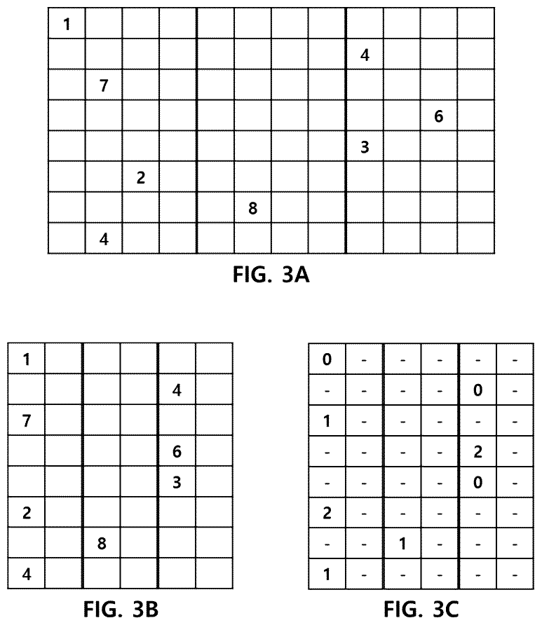

FIGS. 3A to 3C illustrate a data compression operation according to the N:M sparsity rule.

FIG. 3A illustrates an original data matrix, which is a sparse activation matrix, where blanks represent zero (0).

In FIG. 3A, each row contains three data blocks, and each data block contains four data elements.

FIG. 3B illustrates compressed data matrix after applying the 2:4 sparsity rule to the original data matrix in FIG. 3A, and FIG. 3C illustrates metadata corresponding to the compressed data matrix in FIG. 3B.

In FIG. 3B, each row contains three compressed data blocks, and each compressed data block contains two data elements.

In FIG. 3C, each row contains three metadata blocks, and each metadata block contains two metadata elements.

Each metadata element in FIG. 3C represents metadata for a corresponding data element in FIG. 3B. If a data element in FIG. 3B is non-zero, corresponding metadata in FIG. 3C indicates the position of the corresponding data element within a corresponding data block (i.e., the index). If the data element in FIG. 3B is zero (0), the corresponding metadata indicates a ‘don't care’ condition.

The metadata block is stored in the metadata buffer 210 of FIG. 2 and is utilized for both compression and decompression operations.

When the first data block of the first row in the original data matrix shown in FIG. 3A is {1, 0, 0, 0}, the first data block is compressed to {1, 0} after applying the 2:4 sparsity rule thereto. The compressed data block is stored as the first compressed data block in the first row of the compressed data matrix shown in FIG. 3B.

The location of data element 1 in FIG. 3B corresponds to index 0 in the data block of FIG. 3A, so the corresponding metadata block is {0,−}, which is stored as the first metadata block of the first row in FIG. 3C. Here, ‘−’ indicates the ‘don't care’ condition and may be referred to as a ‘don't care’ value.

The memory controller 1000 of FIG. 1 can pre-allocate address spaces for storing compressed data and metadata.

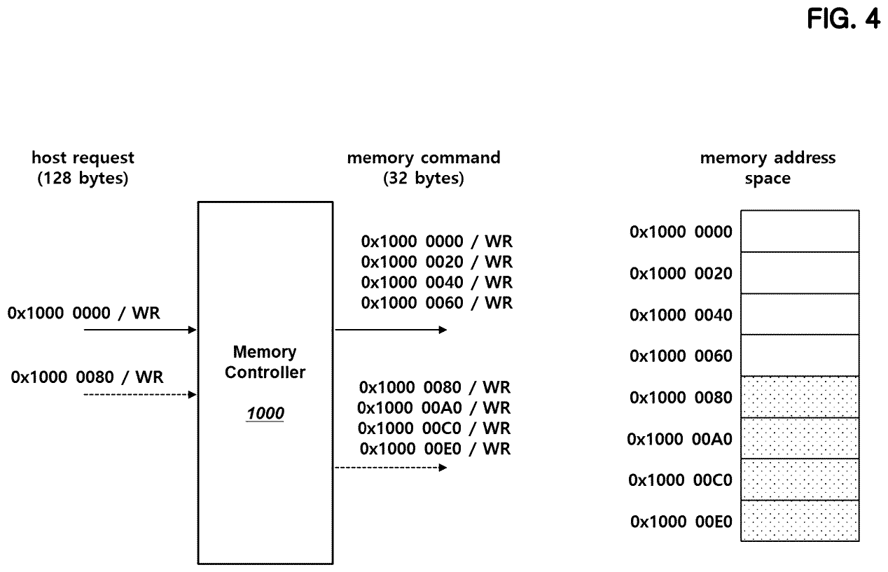

FIGS. 4 to 6 illustrate operations of the memory controller 1000 of FIG. 1 according to an embodiment of the present disclosure.

FIG. 4 shows an operation of the memory controller 1000 when compression is not performed.

In this embodiment, it is assumed that a host request is in 128-byte units, while a memory command operates in 32-byte units.

Accordingly, when compression is not performed, one host request is completed with four memory commands.

Specifically, when the memory controller 1000 receives a single host write request, it generates four consecutive write commands, each in 32-byte units.

FIG. 4 shows that when the address of the first write request provided by the host is ‘0x1000 0000,’ the addresses of the corresponding four write commands are ‘0x1000 0000,’ ‘0x1000 0020,’ ‘0x1000 0040,’ and ‘0x1000 0080.’

In addition, when the address of the second write request provided by the host is ‘0x1000 0080,’ the addresses of the corresponding four write commands are ‘0x1000 0080,’ ‘0x1000 00A0,’ ‘0x1000 00C0,’ and ‘0x1000 00E0.’

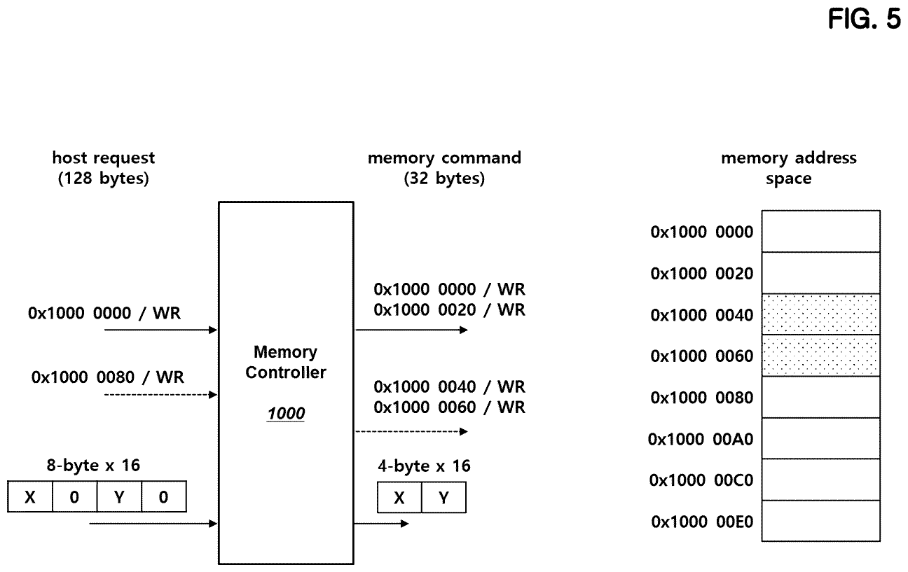

FIG. 5 shows an operation of the memory controller 1000 when compression is performed according to the 2:4 sparsity rule.

In this embodiment, 128-byte data forms 16 data blocks, with each data block containing four 2-byte data elements, i.e., four 16-bit data elements.

In this embodiment, the compression operation according to the 2:4 sparsity rule is performed at the data block level.

Assuming that the first data block among the data corresponding to the first host request is {X, 0, Y, 0}, the compressed data block according to the 2:4 sparsity rule becomes {X, Y}. At this time, X, 0, Y, and 0 each represent 2-byte data element.

Since 16 data blocks correspond to one host request, the compression results in a total of 64-byte data.

When the memory controller 1000 receives one host write request under the 2:4 sparsity rule, it generates two write commands, each in 32-byte units.

FIG. 5 shows that when the address of the first write request provided by the host is ‘0x1000 0000,’ the addresses of the two corresponding write commands are ‘0x1000 0000’ and ‘0x1000 0020.’

Among the two corresponding write commands, the first write command writes the upper 32 bytes of data among the 64-byte data, while the second write command writes the lower 32 bytes of data among the 64-byte data.

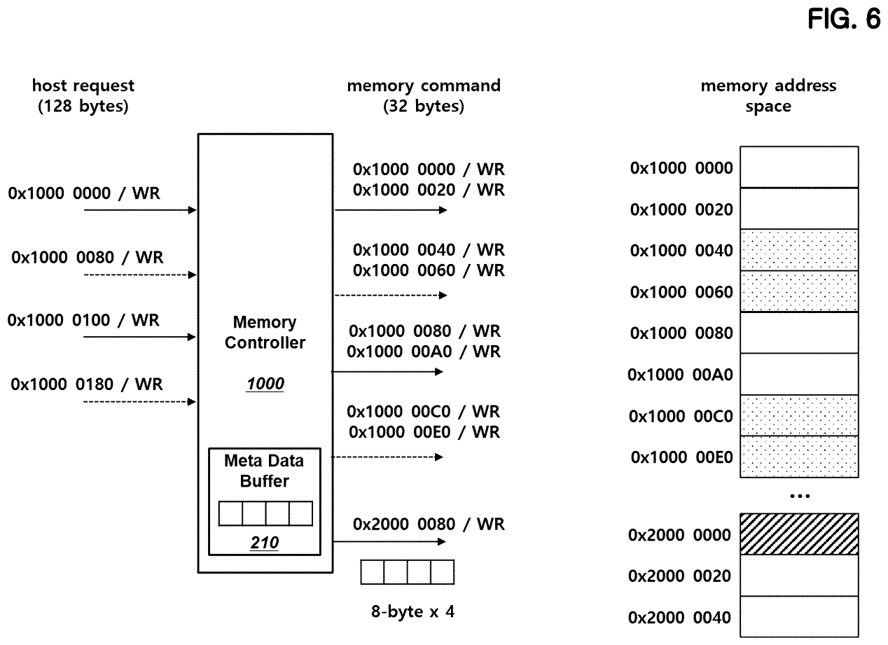

FIG. 6 shows an operation of the memory controller 1000 when a compression operation is performed according to the 2:4 sparsity rule.

FIG. 6 discloses a method of generating metadata during the compression operation and a method of storing the metadata.

When the compression operation is performed according to the 2:4 sparsity rule, metadata must be generated for each data element within the compressed data block. Specifically, metadata corresponding to X and Y in FIG. 5 are generated.

In this embodiment, since each data block contains four data elements, metadata corresponding to each data element consists of 2 bits.

Accordingly, as 16 compressed data blocks, each containing 2 data elements, are generated in response to one host write request, 16 metadata blocks, each containing two 2-bit metadata elements, are generated. Thus, the total size of the metadata corresponding to one write request is 8 bytes.

FIG. 6 shows that a total of 32 bytes of metadata generated in response to 4 host write requests are stored using one write command.

Hereinafter, a ‘first memory command’ represents a memory command for the compressed data block, while a ‘second memory command’ represents a memory command for the metadata.

The addresses used for the first and second memory commands may be configured to have specific relationship with the address for the host request, and this relationship may be predetermined according to various embodiments.

FIG. 6 illustrates an example in which a memory space for storing metadata is allocated starting at ‘0x2000 0000,’ while a memory space for storing compressed data is allocated at an address preceding this.

Since these rules can be designed and changed in various ways by a person skilled in the art, specific details are omitted.

The compression control circuit 200 can generate the addresses for the first and second memory commands based on the address of the host request, following a predetermined rule.

In addition, the address for the second memory command and the address for the host request corresponding to the first memory command can be generated according to the predetermined rule.

In addition, the address for the first memory command and the address for the host request corresponding to the second memory command can be generated according to the predetermined rule.

In this embodiment, the compression operation and the decompression operation can be controlled by the compression control circuit 200.

Specifically, the compression control circuit 200 generates a plurality of first memory commands based on a host request from the request queue 310, inputs the plurality of first memory commands to the scheduler 320, then generates a corresponding second memory command, and also inputs the corresponding second memory command to the scheduler 320.

FIG. 6 shows an example where two first write commands are input to the scheduler 320 in response to a single host write request. Additionally, one second write command is generated in response to four host write requests and is also input to the scheduler 320.

Hereinafter, metadata corresponding to a single host request is referred to as a metadata block, and metadata corresponding to four host requests is referred to as a metadata entry.

In this case, a metadata block generated for each host write request is stored in the metadata buffer 210. Once a metadata entry, consisting of four metadata blocks, is complete, a corresponding second write command is generated and input to the scheduler 320.

In addition, the metadata buffer 210 can manage the validity of a plurality of metadata blocks included in a single metadata entry.

In another embodiment, a metadata block corresponding to each host write request can be individually stored.

In this case, it operates in Read-Modify-Write (RMW) mode, allowing the metadata entry corresponding to the host write request to be updated all at once, while preventing corruption of other metadata blocks within the metadata entry.

If data masking is supported during a memory write operation, it is also possible to store only the corresponding metadata block without performing a data read operation.

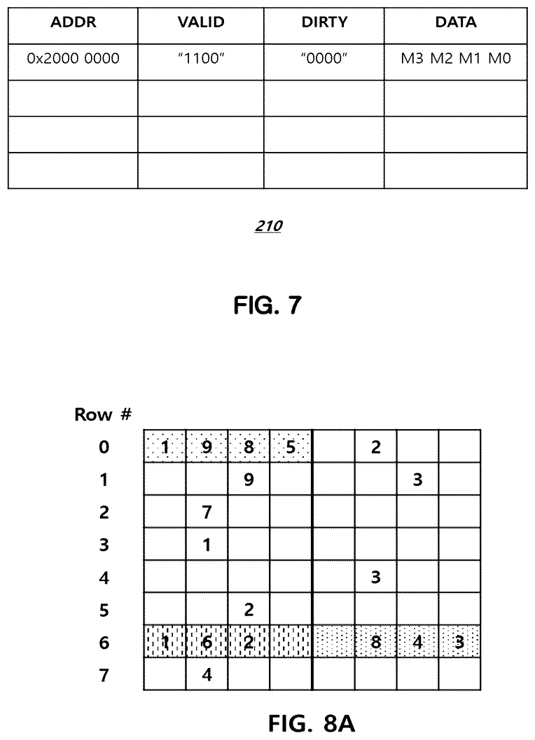

FIG. 7 shows a data structure of a metadata buffer 210 according to an embodiment of the present disclosure. The metadata buffer 210 of FIG. 7 may correspond to the metadata buffer 210 shown in FIG. 2.

In this embodiment, an address field ADDR indicates an address for a metadata entry, a data field DATA stores four metadata blocks, a valid field VALID indicates validity of each of the four metadata blocks, and a dirty field DIRTY indicates whether each of the four metadata blocks has been updated.

When a host read request is received, the compression control circuit 200 of FIG. 2 generates a corresponding number of first memory commands.

The compression control circuit 200 refers to the address field ADDR of the metadata buffer 210. If a corresponding metadata entry is not present in the metadata buffer 210, it generates a second read command to read metadata from the memory device and then stores the metadata entry in the metadata buffer 210.

The valid field VALID of a newly read metadata entry may be set to ‘1111,’ while the dirty field DIRTY may be set to ‘0000.’

When a host write request is received, the compression control circuit 200 either adds a new metadata entry or updates the corresponding metadata block in the existing metadata entry by referring to the address field ADDR of the metadata buffer 210.

When a new metadata entry is added, the valid field VALID may be set to a value ‘1’ at the position corresponding to the meta block generated by the host write request and a value ‘0’ in the other positions. The dirty field DIRTY may be set to ‘0000.’

When adding a metadata block to the existing metadata entry, if a value of the valid field VALID at the corresponding position is 1, the value of the dirty field DIRTY may be set to 1. If the value of the valid field VALID at the corresponding position is 0, it may be updated to 1.

If all metadata blocks are valid and at least one metadata block has been updated, a second write command for writing the corresponding metadata entry in the memory device may be generated.

Since the space in the metadata buffer 210 is limited, the existing metadata entry may be evicted if there is insufficient space. When a metadata entry is evicted, a second write command is generated.

For example, if all four metadata blocks are valid and dirty (or changed), the compression control circuit 200 may generate a second memory command for the corresponding metadata entry and then evict the corresponding metadata entry from the metadata buffer 210.

In order to manage the storage space of the metadata buffer 210, additional information may be stored in the metadata buffer 210.

For example, information regarding the generation time of the corresponding metadata entry, whether the corresponding metadata entry was newly generated, and whether the corresponding metadata entry was read from the memory device may be additionally stored in the metadata buffer 210.

The technique of managing the storage space of the metadata buffer 210 using this additional information can be designed and changed in various ways by a person skilled in the art, based on the present disclosure, so specific details are omitted.

The metadata entry corresponding to the second memory command can be directly transmitted between the metadata buffer 210 and the memory interface circuit 20.

The operation described above pertains to the case where all data blocks corresponding to the host request comply with the N:M sparsity rule.

The following describes the operation when the data blocks corresponding to the host request do not comply with the N:M sparsity rule.

In this case, a row split operation is performed in response to a host write request, and a row merge operation is performed in response to a host read request.

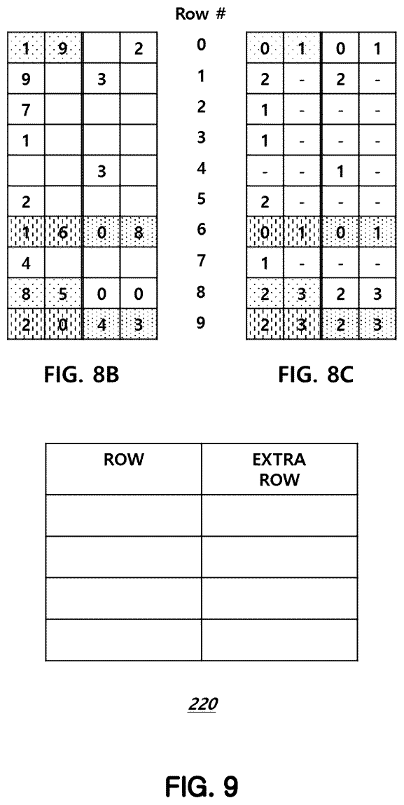

FIGS. 8A to 8C illustrate a row split operation of the compression control circuit 200 of FIG. 1 according to an embodiment of the present disclosure.

In FIGS. 3A to 3C, all data blocks comply with the N:M sparsity rule, but in FIGS. 8A to 8C, some data blocks do not comply with the N:M sparsity rule.

FIG. 8A represents an original data matrix, such as sparse activation matrix. FIG. 8B represents compressed data matrix from FIG. 8A according to the 2:4 sparsity rule, and FIG. 8C represents corresponding metadata.

In FIG. 8A, one row contains two data blocks, and each data block contains four data elements.

In FIG. 8A, data blocks, except for the first block of row #0 and the two data blocks of row #6, comply with the 2:4 sparsity rule. Therefore, the compression operation for these blocks is performed in the same manner as described in FIGS. 3A to 3C.

If a data block contains three or four non-zero data elements, it violates the 2:4 sparsity rule. In this embodiment, multiple compressed data blocks are generated from such data blocks and stored in separate rows.

For example, the first data block of row #0 is {1, 9, 8, 5}. From this, two compressed data blocks {1, 9} and {8, 5} are generated and stored in separate rows.

In FIG. 8B, the compressed data block {1, 9} is stored as the first compressed data block of row #0. The metadata corresponding to the data elements of the compressed data block {1, 9} are 0 and 1, which are stored as the first metadata block of row #0 in FIG. 8C.

The compressed data block {8, 5} is stored as the first data block of row #8, as shown in FIG. 8B. The metadata corresponding to the data elements of the first data block {8, 5} are 2 and 3, which are stored as the first metadata block of row #8 in FIG. 8C.

In addition, the second data block of the row #6 is {0, 8, 4, 3}. From this, two compressed data blocks {0, 8} and {4, 3} are generated and stored in separate rows.

In FIG. 8B, the compressed data block {0, 8} is stored as the second compressed data block of the row #6. The metadata corresponding to the data elements of the second compressed data block {0, 8} are 0 and 1, which are stored as the second metadata block of the row #6 in FIG. 8C.

The compressed data block {4, 3} is stored as the second compressed data block of the row #9, as shown in FIG. 8B. The metadata corresponding to the data elements of the second compressed data block {4, 3} are 2 and 3, which are stored as the second metadata block of the row #9 in FIG. 8C.

In this way, the compression control circuit 200 generates a plurality of compressed data blocks from data blocks that do not comply with the N:M sparsity rule, ensuring they meet the sparsity rule, and stores them in separate rows. This process is referred to as a row split operation.

In the row split operation, one data block is associated with multiple compressed data blocks stored in different rows.

The mapping table 220 of FIG. 2 stores the associations between data blocks and their corresponding compressed data blocks.

FIG. 9 shows a data structure of a mapping table 220 according to an embodiment of the present disclosure. The mapping table 220 of FIG. 9 may correspond to the mapping table 220 of FIG. 2.

The mapping table 220 includes a row field ROW and an additional row field EXTRA ROW.

The row field ROW indicates a row address of a first compressed data block generated from a data block that does not comply with the N:M sparsity rule. The additional row field EXTRA ROW indicates a row address corresponding to an additional compressed data block associated with the first compressed data block.

In FIGS. 8A to 8C, there is only one additional compressed data block. However, if multiple additional compressed data blocks are generated, multiple row addresses can be stored sequentially in the additional row field EXTRA ROW.

In this case, the row address can be replaced with a row number.

For example, if the start address of the memory space where the compressed data block is stored and the start address of the memory space where the additional compressed data block is stored are determined according to a predetermined rule, the relationship between the row number and the row address in FIGS. 8A to 8C can be derived according to the predetermined rule, Consequently, the row number corresponding to the row address can be stored as well.

For example, in FIGS. 8A to 8C, it is assumed that each compressed data block contains 32 bits, and the memory device processes data in 32-bit units.

In this case, two row numbers are assigned to each row in FIG. 8B.

Assuming that the row number for the first compressed data block {1, 9} of row #0 is 0, this value ‘0’ is added to the row field ROW. Additionally, the row number for the additional compressed data block {8, 5} of row #8 can be added to the additional row field EXTRA ROW.

If the memory space for the additional compressed data block generated by the row split operation is set separately, and the compressed data block {8, 5} is recorded as the first row in the corresponding area, then 0, rather than 8, may be stored in the additional row field EXTRA ROW.

As described above, instead of storing the row number, the row address itself can be stored in the mapping table 220.

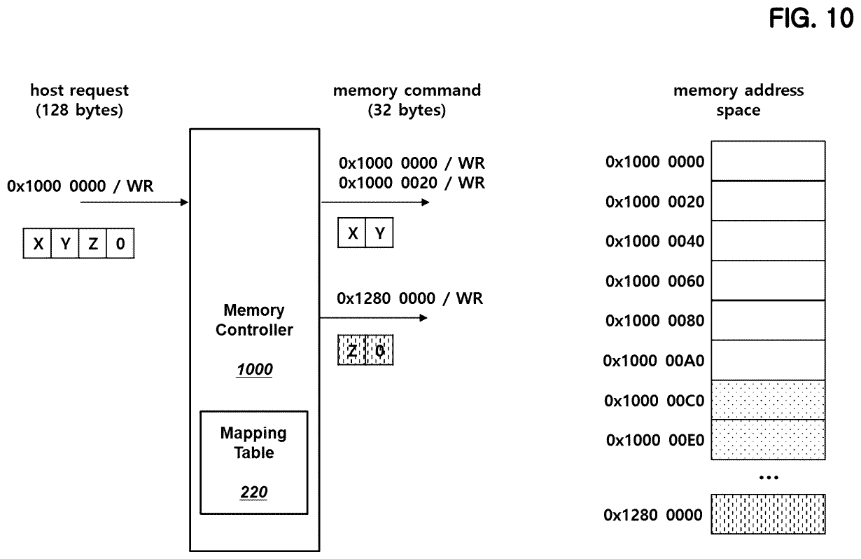

FIG. 10 is a diagram showing an operation of a memory controller 1000 according to an embodiment of the present disclosure. The memory controller 1000 of FIG. 10 may correspond to the memory controller 1000 shown in FIG. 1.

Generating a plurality of first memory commands and a second memory command for a single host request is as described above, so further description is omitted.

In FIG. 10 a row split operation is assumed to be included in processing a host request.

For example, it is assumed that when a host write request for “0x1000 0000” is made, write data includes a first data block and a second data block, and the first data block does not comply with the 2:4 sparsity rule.

Assuming that the first data block is {X, Y, Z, 0}, the compression control circuit 200 generates a first compressed data block {X, Y} and an additional compressed data block {Z, 0} corresponding thereto.

The compression control circuit 200 also generates a second compressed data block corresponding to the second data block.

The compression control circuit 200 stores the relationship between the first compressed data block {X, Y} and the additional compressed data block {Z, 0} in the mapping table 220.

As described above, the compression control circuit 200 updates the metadata information in the metadata buffer 210 to be associated with the first compressed data block {X, Y} and the second compressed data block.

When performing a row split operation, the compression control circuit 200 must add information to the metadata buffer 210 for the additional compressed data block {Z, 0}.

This means that the compression control circuit 200 must issue a third write command for the additional compressed data block {Z, 0} and a fourth write command for an additional metadata block associated with the additional compressed data block {Z, 0}.

When processing a host read request, the compression control circuit 200 checks the mapping table 220 to determine if additional compressed data exists.

If no additional compressed data is found, the decompression operation is performed using only the information stored in the metadata buffer 210 and the N:M sparsity rule.

On the other hand, if additional compressed data is present, the decompression operation must be performed using the compressed data, the additional compressed data, and associated metadata.

In this case, a third memory read command for the additional compressed data and a fourth memory read command for metadata corresponding to the additional compressed data must also be issued.

Although various embodiments have been illustrated and described, various changes and modifications may be made to the described embodiments without departing from the spirit and scope of the invention as defined by the following claims.

What is claimed is:

1. A memory controller comprising:
a host interface circuit configured to receive a host read request, a host write request, and a data block corresponding to the host write request from a host;
a compression control circuit configured to generate a compressed data block by compressing the data block based on an N:M sparsity rule and generate a metadata block including metadata for data elements included in the compressed data block;
a scheduler configured to schedule a first write command for writing the compressed data block and a second write command for writing the metadata block; and
a memory interface circuit configured to transmit a memory command output from the scheduler to a memory device,
wherein N and M are natural numbers and an M is greater than N.

2. The memory controller of claim 1, wherein the compression control circuit includes a metadata buffer storing the metadata block.

3. The memory controller of claim 2, wherein, during a read operation, the compression control circuit generates a first read command for reading the compressed data block in response to the host read request, and generates a second read command for reading the metadata block from the memory device when the metadata block does not exist in the metadata buffer, and the scheduler schedules the first read command and the second read command.

4. The memory controller of claim 3, wherein the compression control circuit generates a data block corresponding to the host read request by referring to the compressed data block received by the first read command and the metadata block corresponding to the compressed data block.

5. The memory controller of claim 2, wherein the compression control circuit further includes a mapping table, and
wherein, when the compression control circuit generates the compressed data block and additional compressed data block from the data block, the mapping table stores relationships between the compressed data block and the additional compressed data block.

6. The memory controller of claim 5, wherein the compression control circuit generates the compressed data block and the additional compressed data block from the data block when a number of non-zero elements per M elements included in the data block are greater than N,
wherein the compression control circuit generates an additional metadata block corresponding to the additional compressed data block, and
wherein the compression control circuit further generates a third write command for the additional compressed data block, and a fourth write command for the additional metadata block.

7. The memory controller of claim 6, wherein the compression control circuit generates a first read command for reading a first compressed data block corresponding to the host read request, and further generates a third read command for reading a first additional compressed data block corresponding to the first compressed data block when information for the first additional compressed data block exists in the mapping table.

8. The memory controller of claim 7, wherein the compression control circuit further generates a fourth read command for reading a first additional metadata block, corresponding to the first additional compressed data block, from the memory device when the first additional metadata block does not exist in the metadata buffer.

9. The memory controller of claim 7, wherein the compression control circuit generates a data block corresponding to the host read request based on the first compressed data block, the first additional compressed data block, the first metadata block, and the first additional metadata block.

10. An operation method of a memory controller, the operation method comprising:
receiving a data block corresponding to a host write request from a host;
generating a compressed data block by compressing the data block based on an N:M sparsity rule;
generating a metadata block including metadata for data elements included in the compressed data block;
generating a first write command for writing the compressed data block in a memory device; and
generating a second write command for writing the metadata block in the memory device,
wherein N and M are natural numbers and M is greater than N.

11. The operation method of claim 10, wherein the second write command is generated when all metadata included in the metadata block are valid.

12. The operation method of claim 10, further comprising:
generating a first read command for reading a first compressed data block corresponding to a host read request;
generating a second read command for reading a first metadata block corresponding to the first compressed data block; and
generating a data block corresponding to the host read request based on the first compressed data block and the first metadata block.

13. The operation method of claim 10, further comprising:
generating an additional compression data block when a number of non-zero elements among M elements included in the data block is greater than N;
storing relationships between the compressed data block and the additional compressed data block;
generating an additional metadata block including metadata for data elements included in the additional compressed data block;
generating a third write command for writing the additional compressed data block; and
generating a fourth write command for writing the additional metadata.

14. The operation method of claim 13, further comprising:
generating a first read command for reading a first compressed data block corresponding to a host read request;
generating a third read command for reading a first additional compressed data block corresponding to the first compressed data block when information for the first additional compressed data block exists in the relationships;
generating a fourth read command for reading a first additional metadata block corresponding to the first additional compressed data; and
generating a data block corresponding to the host read request based on the first compressed data block, the first additional compressed data block, a first meta data block corresponding to the first compressed data block, and the first additional meta data block.
